(19) United States
(12) Patent Application Publication
(10) Pub. No.: US 2023/0239820 A1
(43) Pub. Date: Jul. 27, 2023

(54) METHOD AND APPARATUS FOR DETERMINING DRX RTT TIMER

(71) Applicant: LENOVO (BEIJING) LIMITED, Beijing (CN)

(72) Inventors: Jing HAN, Beijing (CN); Min XU, Beijing (CN); Haiming WANG, Beijing (CN)

(21) Appl. No.: 18/007,175

(22) PCT Filed: Jul. 28, 2020
(86) PCT No.: PCT/CN2020/105247

§ 371 Date: Jan. 27, 2023

(51) Int. Cl. H04W 56/00

(52) U.S. Cl. CPC H04W 56/0045

(57) ABSTRACT

The present application relates to a method and an apparatus for determining DRX RTT timer. One embodiment of the subject application provides a method for determining a Discontinuous Reception (DRX) Round-Trip Time (RTT) timer, which includes: determining an offset value based on at least one of the following parameters: a timing advance value, a common offset value, ephemeris information, and an offset value of a timing advance; and determining the DRX RTT timer with the offset value.

### TECHNICAL FIELD

The subject application relates to wireless communication technology, and more particularly, related to a method and an apparatus for determining a discontinuous reception (DRX) Round-Trip Time (RTT) timer.

### BACKGROUND OF THE INVENTION

Legacy Hybrid Automatic Repeat reQuest (HARQ) RTT timer for DRX is designed for a user equipment (UE) to wait during the round trip time for feedback time and scheduling time between a Base Station (BS) and a UE. The round trip delay which is caused by the distance of BS and UE in New Radio (NR) is in the order of several microseconds, thus such time is negligible and not considered in HARQ RTT timer for DRX. However, there are networks having large round trip delay (RTD) caused by large distance between BS and UE, ranging from several milliseconds to hundreds of milliseconds, which is necessary to be considered during DRX operation.

Therefore, it is desirable to provide a solution to incorporate the impact of large RTD on legacy HARQ RTT timer for DRX operation.

### SUMMARY

The present disclosure proposes to add an offset value to the HARQ RTT timer to reduce the waiting time of the UE.

One embodiment of the subject application provides a method for determining a Discontinuous Reception (DRX) Round-Trip Time (RTT) timer, which includes: determining an offset value based on at least one of the following parameters: a timing advance value, a common offset value, ephemeris information, and an offset value of a timing advance; and determining the DRX RTT timer with the offset value.

Another embodiment of the subject application provides a method for determining a Discontinuous Reception (DRX) Round-Trip Time (RTT) timer, which includes: receiving the DRX RTT timer, wherein the DRX RTT timer includes an indicator indicating the DRX RTT timer is for a specific network with large delay variations; and applying the DRX RTT timer when a User Equipment (UE) is served by the specific network.

Yet another embodiment of the subject application provides a method for determining a Discontinuous Reception (DRX) Round-Trip Time (RTT) timer, which includes: receiving an adjustment configuration from a base station (BS); adjusting the offset value when a user equipment (UE) is allowed to adjust the offset value; and determining the DRX RTT timer based on adjusted offset value.

Still another embodiment of the subject application provides an apparatus, which includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method for determining a Discontinuous Reception (DRX) Round-Trip Time (RTT) timer, comprising: determining an offset value based on at least one of the following parameters: a timing advance value, a common offset value, ephemeris information, and an offset value of a timing advance; and determining the DRX RTT timer with the offset value.

### BRIEF DESCRIPTION OF THE DRAWINGS

FIG. 1 illustrates a schematic diagram of a wireless communication system in accordance with some embodiments of the subject disclosure.

FIG. 2 illustrates one method performed by a UE for wireless communication according to a preferred embodiment of the subject disclosure.

FIG. 3 illustrates another method performed by a UE for wireless communication according to a preferred embodiment of the subject disclosure.

FIG. 4 illustrates another method performed by a UE for wireless communication according to a preferred embodiment of the subject disclosure.

FIG. 5 illustrates a block diagram of a UE according to the embodiments of the subject disclosure.

### DETAILED DESCRIPTION

The detailed description of the appended drawings is intended as a description of the preferred embodiments of the present invention, and is not intended to represent the only form in which the present invention may be practiced. It should be understood that the same or equivalent functions may be accomplished by different embodiments that are intended to be encompassed within the spirit and scope of the present invention.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

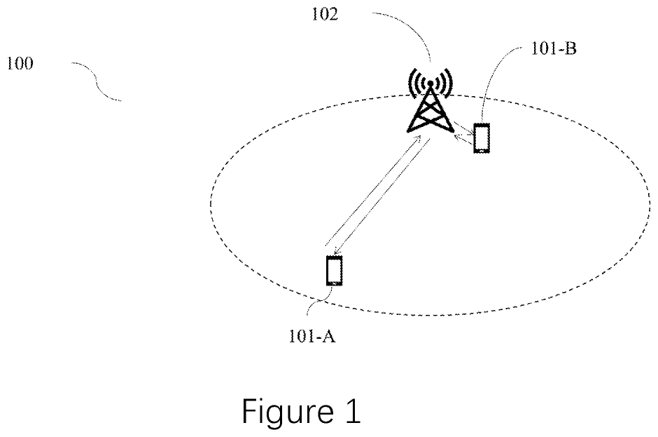

FIG. 1 depicts a wireless communication system 100 according to an embodiment of the present disclosure.

As shown in FIG. 1, the wireless communication system 100 includes two UEs, UE 101-A, 101-B and a base station 102. Even though there are only two UEs and one BS in FIG. 1, one of skill in the art will recognize that any number of user equipment and base stations may be included in the wireless communication system 100. The wireless communication system 100 may be a non-terrestrial network (NTN). Compared with the UE 101-B, the UE 101-A is located at a further location with respect to the BS 102, therefore, the RTD of the UE 101-A is larger than that of the UE 101-B. That is to say, different UEs in the same network might have different RTDs.

The UE 101-A may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, the UE 101-A may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101-A includes wearable devices, such as smart watches, fitness bands, optical head-mounted displays, or the like. Moreover, the UE 101-A may be referred to as subscriber units, mobiles, mobile stations, users, terminals, mobile terminals, wireless terminals, fixed terminals, subscriber stations, user terminals, a device, or by other terminology used in the art. The UE 101-A may communicate directly with the BS 102 via uplink (UL) communication signals.

The BS 102 may be distributed over a geographic region. In NTN system, the stations 102 may be a satellite. In certain embodiments, the BS 102 may also be referred to as an access point, an access terminal, a base, a base station, a macro cell, a Node-B, an enhanced Node B (eNB), a Home Node-B, a relay node, a device, or by any other terminology used in the art. The BS 102 may be generally a part of a radio access network that may include one or more controllers communicably coupled to one or more corresponding base stations.

The wireless communication system 100 is compliant with any type of network that is capable of sending and receiving wireless communication signals. For example, the wireless communication system 100 is compliant with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a LTE network, a 3rd Generation Partnership Project (3GPP)-based network, 3GPP 5G network, a satellite communications network, a high altitude platform network, and/or other communications networks.

In one implementation, the wireless communication system 100 is compliant with the NR of the 3GPP protocol, wherein the BS 102 transmits using an orthogonal frequency division multiplexing (OFDM) modulation scheme on the DL and the UE 101-A transmits on the UL using a single-carrier frequency division multiple access (SC-FDMA) scheme or OFDM scheme. More generally, however, the wireless communication system 100 may implement some other open or proprietary communication protocol, for example, WiMAX, among other protocols.

In other embodiments, the BS 102 may communicate using other communication protocols, such as the IEEE 802.11 family of wireless communication protocols. Further, in some embodiments the BS 102 may communicate over licensed spectrum, while in other embodiments the BS 102 may communicate over unlicensed spectrum. The present disclosure is not intended to be limited to the implementation of any particular wireless communication system architecture or protocol. In another embodiment, the BS 102 may communicate with the UE 101-A using the 3GPP 5G protocols.

Currently, a work item on “Solutions for NR to support non-terrestrial networks (NTN)” was approved. One objective related to DRX scheme in NTN is: if HARQ feedback is enabled, introduction of offset for downlink DRX HARQ RTT, which is represented as drx-HARQ-RTT-TimerDL, and for uplink DRX HARQ RTT, which is represented as drx-HARQ-RTT-TimerUL. If HARQ is turned off per HARQ process, adaptions in HARQ procedure.

According to legacy HARQ RTT timer for DRX, the UE needs to wait during round trip time between the BS and the UE. The round trip delay is the time required to wait for feedback time and scheduling time between a Base Station (BS) and a UE. The round trip delay (RTD) for a signal to travel from the UE to the BS or from the BS to the UE and back is usually very small, e.g. in the order of several microseconds, thus such time is negligible and not considered in legacy HARQ RTT timer for DRX

However, there are wireless communication systems having large RTD between the BS and the UE. For example, the RTD in the NTN system may reach hundreds of milli-seconds according to 3GPP documents. Therefore, it is necessary to add an offset to the HARQ RTT timer, to accommodate with large RTD of some communication systems. Otherwise, the UE might have to unnecessarily monitor for Physical Downlink Control Channel (PDCCH) which would waste UE power.

In NTN systems, the distance between the NTN node and the terrestrial UE is relative long, which will cause large RTD between the NTN node and the terrestrial UE. For example, the RTD values for different NTN scenarios are presented in Table 1 below:

TABLE 1

| NTN scenarios | A | B | C1 | C2 | D1 | D2 |
|---|---|---|---|---|---|---|
| | GEO | GEO | LEO | | LEO | |
| | transparent | regenerative | transparent | | regenerative | |
| | payload | payload | payload | | payload | |
| Satellite altitude | 35786 km | | 600 km | | | |
| Maximum propagation delay | 541.46 ms | 270.73 ms | 25.77 | ms | 12.89 | ms |
| contribution to the Round | (Worst case) | | | | | |
| Trip Delay on the radio | | | | | | |
| interface between the | | | | | | |
| gNB and the UE | | | | | | |
| Minimum propagation delay | 477.48 ms | 238.74 ms | 8 | ms | 4 | ms |
| contribution to the Round | | | | | | |
| Trip Delay on the radio | | | | | | |
| interface between the | | | | | | |
| gNB and the UE | | | | | | |

According to Table 1, for NTN scenario A with GEO transparent payload, the satellite altitude is 35786 km, that is, the distance between a satellite BS and the UE is long, correspondingly, the maximum propagation delay contribution to the Round Trip Delay on the radio interface between the gNB and the UE is 541.46 ms. The minimum propagation delay contribution to the Round Trip Delay on the radio interface between the gNB and the UE is 477.48 ms. For NTN scenario D1 and D2 with LEO regenerative payload, the maximum propagation delay contribution to the Round Trip Delay on the radio interface between the gNB and the UE is 12.89 ms, and the minimum propagation delay contribution to the Round Trip Delay on the radio interface between the gNB and the UE is 4 ms. Therefore, the RTD in the NTN networks might not be ignored.

Furthermore, the RTD values are not only different for different scenarios, and also different even for the same scenario.

For instance, the propagation delay can be varies as seen by UE, especially for LEO scenarios, for example, scenarios C and D. The delay variation measures how fast the RTD varies over time when the satellite moves towards or away from the UE. The maximum delay variation in different scenarios are presented in Table 2 below:

TABLE 2

| | | | | | | |
|---|---|---|---|---|---|---|
| NTN scenarios | A | B | C1 | C2 | D1 | D2 |

| | | | |
|---|---|---|---|
| GEO | GEO | LEO | LEO |
| transparent | regenerative | transparent | regenerative |
| payload | payload | payload | payload |

| | | | |
|---|---|---|---|
| Maximum Delay variation | Negligible | Up to +/−40 μs/sec | Up to +/−20 |
| as seen by the UE (note 2) | | (Worst case) | μs/sec |

For scenarios A and B, the Geostationary satellite has a circular orbit at 35,786 km above the Earth's equator and following the direction of the Earth's rotation. An object in such an orbit has an orbital period equal to the Earth's rotational period and thus appears motionless, at a fixed position in the sky, to ground observers. Thus, the delay variation as seen by the UE is negligible.

However, for the low earth orbit satellites, which orbit around the Earth with an altitude between 300 km, and 1500 km. They do not appear motionless to the ground UEs. For example, for scenario Cl, the delay varies for worst case could be +/−40 μs/sec, consider the max NTN beam foot print 1000 km and relative speed of Satellite with respect to earth 7.56 km/sec, there could be up to 5 ms variation for RTD. This relatively large variation value taking the RTD range for scenario Cl is from 8 ms to 25.77 ms into consideration. Accordingly, such delay variation needs to be addressed when utilizing offset value for downlink DRX HARQ RTT, drx-HARQ-RTT-TimerDL, and for uplink DRX HARQ RTT, drx-HARQ-RTT-TimerUL.

In view of the above, the present disclosure proposes solutions for the UE to determine the offset value, so that the DRX HARQ RTT timer can be adjusted according to offset value.

The offset for DRX RTT timer may be determined based on timing advance (TA) value between downlink and uplink, which is represented with N_{TA} in the present disclosure. UE would maintain the TA value which is used for uplink synchronization for Radio Resource Control (RRC) CONNECTED mode. The initial TA value is received in Timing Advance Command (TAC) in Random Access Response (RAR) message or Message B (MSGB). The initial TA value may also be received in Absolute TAC in response to a Message A (MSGA) transmission including Cell Radio Network Temporary Identifier (C-RNTI) Media Access Control (MAC) Control Element (CE). After that, the BS may adjust the TA value using the TAC MAC CE. Correspondingly, after receiving the TAC MAC CE with TA adjustment, the UE will then adjust the TA value according to the maintained TA value and TA adjustment in TAC MAC CE.

There are several solutions for determining the offset value for calculating the DRX HARQ RTT timer. In one solution, the offset value is equal to the TA value obtained from physical layer, which is represented as N_{TA}, and thus offset value=N_{TA}.

In another method, the BS might broadcast a common offset value in system information. In this case, the offset value equals to the maintained TA value plus the common offset value, that is, offset value=N_{TA}+common offset value. The common offset value may be positive or negative, depending on specific conditions.

In another approach, the BS might indicate an offset value for the timing advance value, which is represented with N_{TA_offset}, in the TAC MAC CE. In this case, the offset value equals to the offset value plus the offset for the timing advance value, i.e. offset value=offset value+N_{TA_offset}.

In another embodiment, the offset value may be determined based on ephemeris information. The ephemeris information may include the satellite orbit and the satellite motion information of a satellite. Based on the ephemeris information, the UE can determine the position of the satellite, and calculate the distance between the satellite and the UE, and thus the RTD between the satellite and the UE can be determined by the UE. To sum up, the offset value can be calculated based on the ephemeris information, which is represented as ephemeric_info, therefore, offset value=f(ephemeric_info). The calculation of the offset value can be achieved by UE implementation.

After determining the offset value, the UE determines the DRX HARQ RTT timer using the determined offset value. The determination of the offset value and the DRX HARQ RTT timer may take place at different time occasions.

For the first occasion, the determination is performed after Timing Advance Command MAC CE being received and applied. The UE may determine the offset value and calculate DRX HARQ RTT timer from maintained N_{TA} value after Timing Advance Command MAC CE is received and applied. More specifically, the UE may receive a TAC MAC CE, and apply the received Timing Advance Command and adjust the maintained TA value. Then UE obtains the adjusted TA value from the physical layer, determines it as the offset value for DRX RTT timer, and updates the DRX RTT timer with the adjusted TA value.

The 3GPP specification might be modified as follows (the modified parts are underlined):

```
1> when a Timing Advance Command MAC CE is received, and if an
  N_{TA} has been maintained with the indicated Timing Advance Group
  (TAG):
  2> apply the Timing Advance Command for the indicated TAG;
  2> [determine or derive offset value for DRX RTT timer based on
  TA value]
  2> start or restart the timeAlignmentTimer associated with the indicated
  TAG.
```

The sentence “determine or derive offset value for DRX RTT timer based on TA value” mentioned above and hereinafter is a general description, which may include all the options mentioned above. For example, it might include all the manners for determining the offset values.

For the second occasion, the determination is performed after Timing Advance Command MAC CE being received in a RAR message or in a MSGB and applied. More specifically, the UE may receive the TAC MAC CE in a RAR message or in a MSGB, the UE then applies the TAC as the TA value N_{TA}. Afterwards, the UE obtains the offset value, N_{TA} from the physical layer and calculates the DRX HARQ RTT timer.

The 3GPP specification might be modified as follows (the modified parts are underlined):

```
1> when a Timing Advance Command is received in a Random Access
  Response message for a Serving Cell belonging to a TAG or in a
  MSGB for an SpCell:
  2> if the Random Access Preamble was not selected by the MAC
    entity among the contention-based Random Access Preamble:
    3> apply the Timing Advance Command for this TAG;
    3> [determine or derive offset value for DRX RTT timer based
      on TA value]
    3> start or restart the timeAlignmentTimer associated with this TAG.
  2> else if the timeAlignmentTimer associated with this TAG is not
  running:
    3> apply the Timing Advance Command for this TAG;
    3> [determine or derive offset value for DRX RTT timer based
      on TA value]
    3> start the timeAlignmentTimer associated with this TAG;
    3> when the Contention Resolution is considered not successful; or
    3> when the Contention Resolution is considered successful for SI
      request, after transmitting HARQ feedback for MAC PDU
      including UE Contention Resolution Identity MAC CE:
      4> stop timeAlignmentTimer associated with this TAG.
```

For the third occasion, the determination is performed after absolute TAC being received in response to a MSGA transmission including C-RNTI MAC CE and being applied. That is, the UE may receive an Absolute TAC MAC CE, and apply the received Absolute TAC as the TA value, N_{TA}. After that, the UE obtains the TA value, N_{TA}, from physical layer, determines the TA value from physical layer as the offset value for DRX RTT timer, and updates the DRX RTT timer.

The 3GPP specification might be modified as follows (the modified parts are underlined):

```
1> when an Absolute Timing Advance Command is received in response
  to a MSGA transmission including C-RNTI MAC CE:
  2> apply the Timing Advance Command for PTAG;
  2> [determine or derive offset value for DRX RTT timer based on
  TA value]
  2> start or restart the timeAlignmentTimer associated with PTAG.
```

For the fourth occasion, the determination is performed after DRX being configured or reconfigured. After receiving the DRX configuration from the higher layer, the UE obtains the TA value, N_{TA}, from physical layer, determines it as the offset value for DRX RTT timer, and updates the DRX RTT timer.

The 3GPP specification might be modified as follows (the modified parts are underlined):

```
When DRX is configured, the MAC entity shall:
  1> [determine or derive offset value for DRX RTT timer based on
  TA value]
  1> if a MAC PDU is received in a configured downlink assignment:
    2> start the drx-HARQ-RTT-TimerDL for the corresponding
      HARQ process in the first symbol after the end of the
      corresponding transmission carrying the DL HARQ feedback;
```

For the fifth occasion, the determination is performed before a timer for uplink or downlink transmission of DRX RTT HARQ being started.

For one example, after receiving a MAC Protocol Data Unit (PDU) in a configured downlink assignment, and before the timer drx-HARQ-RTT-TimerDL being started, the UE obtains the TA value, N_{TA}, from physical layer, determines it as the offset value for DRX RTT timer, and updates the DRX RTT timer. The DRX RTT timer is calculated as: drx-HARQ-RTT-TimerDL=drx-HARQ-RTT-TimerDL+[offset value].

For another example, after transmitting a MAC PDU in a configured uplink grant, and before the timer drx-HARQ-RTT-TimerUL being started, the UE obtains the TA value, N_{TA}, from physical layer, determines it as the offset value for DRX RTT timer, and updates the DRX RTT timer. The DRX RTT timer is calculated as: drx-HARQ-RTT-TimerUL=drx-HARQ-RTT-TimerUL+[offset value].

The 3GPP specification might be modified as follows (the modified parts are underlined):

```
When DRX is configured, the MAC entity shall:
  1> if a MAC Protocol Data Unit (PDU) is received in a configured
    downlink assignment:
    2> [determine or derive offset value for DRX RTT timer based
    on TA value]
    2> start the drx-HARQ-RTT-TimerDL for the corresponding
      HARQ process in the first symbol after the end of the
      corresponding transmission carrying the DL HARQ feedback;
    2> stop the drx-RetransmissionTimerDL for the corresponding
      HARQ process.
1> if a MAC PDU is transmitted in a configured uplink grant:
  2> [determine or derive offset value for DRX RTT timer based on
  TA value]
  2> start the drx-HARQ-RTT-TimerUL for the corresponding HARQ
    process in the first symbol after the end of the first repetition of the
    corresponding PUSCH transmission;
  2> stop the drx-RetransmissionTimerUL for the corresponding HARQ
    process.
```

For the third example, after receiving PDCCH indicates a DL transmission, and before the timer drx-HARQ-RTT-TimerDL being started, the UE obtains the TA value, N_{TA}, from physical layer, determines it as the offset value for DRX RTT timer, and updates the DRX RTT timer. The DRX RTT timer is calculated as: drx-HARQ-RTT-TimerDL=drx-HARQ-RTT-TimerDL+[offset value].

The 3GPP specification might be modified as follows (the modified parts are underlined):

```
1> if the MAC entity is in Active Time:
  2> monitor the PDCCH;
  2> if the PDCCH indicates a DL transmission:
    3> [determine or derive offset value for DRX RTT timer based
      on TA value]
    3> start the drx-HARQ-RTT-TimerDL for the corresponding HARQ
      process in the first symbol after the end of the corresponding
      transmission carrying the DL HARQ feedback, regardless of LBT
      failure indication from lower layers;
```

For the fourth example, after receiving PDCCH indicates a UL transmission, and before the timer drx-HARQ-RTT-TimerUL being started, the UE obtains the TA value, N_{TA}, from physical layer, determines it as the offset value for DRX RTT timer, and updates the DRX RTT timer. The DRX RTT timer is calculated as: drx-HARQ-RTT-TimerUL=drx-HARQ-RTT-TimerUL+[offset value].

The 3GPP specification might be modified as follows (the modified parts are underlined):

```
1> if the MAC entity is in Active Time:
  2> monitor the PDCCH;
  ...
  2> if the PDCCH indicates a UL transmission:
    3> [determine or derive offset value for DRX RTT timer based
      on TA value]
    3> start the drx-HARQ-RTT-TimerUL for the corresponding HARQ
      process in the first symbol after the end of the first repetition of the
      corresponding PUSCH transmission, regardless of LBT failure
      indication from lower layers;
```

In the above content, it is the UE that determines the DRX HARQ RTT timer. Alternatively, the network may directly configure the DRX HARQ RTT timer for the UE and transmit the timer in RRC Reconfiguration message, the timer may be represented as DRX-Config. After the UE receives the configuration, the UE directly applies the received timer when the UE is served by the network with large RTD. For example, the network may be an NTN network, which has large RTD, and when the UE is served by the NTN nodes, it uses the DRX HARQ RTT timer received from the network.

The present disclosure introduces two new timers for DRX HARQ RTT timer for the networks with large RTD. When the networks with large RTD is an NTN system, the downlink DRX HARQ RTT timer for NTN system may be represented as, drx-HARQ-RTT-TimerDL-NTN, and the uplink DRX HARQ RTT timer may be represented as, drx-HARQ-RTT-TimerUL-NTN. Then the 3GPP documents regarding the two timers in the RRC Reconfiguration message might be modified as follows (the modified parts are underlined):

```
RRC controls DRX operation by configuring the following parameters:
  - drx-HARQ-RTT-TimerDL-NTN (per DL HARQ process except
    for the broadcast process): the minimum duration before
    a DL assignment for HARQ retransmission is expected
    by the MAC entity for NTN usage;
  - drx-HARQ-RTT-TimerUL-NTN (per UL HARQ process): the
    minimum duration before a UL HARQ retransmission grant is
    expected by the MAC entity for NTN usage;
```

When DRX is configured for the UE, the UE may directly apply the timer, drx-HARQ-RTT-TimerDL-NTN configured by the BS, and the 3GPP specification might be modified as follows (the modified parts are underlined):

```
When DRX is configured, the MAC entity shall:
  1> if a MAC PDU is received in a configured downlink assignment:
    2> if drx-HARQ-RTT-TimerDL-NTN is configured
      3> start the drx-HARQ-RTT-TimerDL-NTN for the
        corresponding HARQ process in the first symbol after
        the end of the corresponding transmission carrying the
        DL HARQ feedback;
    2> else
```

```
    3> start the drx-HARQ-RTT-TimerDL for the corresponding
      HARQ process in the first symbol after the end of the
      corresponding transmission carrying the DL HARQ feedback;
2> stop the drx-RetransmissionTimerDL for the corresponding HARQ
  process.
```

Since the two new timers for NTN networks are introduced, then the UE needs to determine whether it is served by non-NTN nodes or NTN nodes when downlink or uplink DRX HARQ RTT timer has being started. The 3GPP specification might be modified as follows (the modified parts are underlined):

```
1> if a drx-HARQ-RTT-TimerDL or drx-HARQ-RTT-TimerDL-NTN
expires:
  2> if the data of the corresponding HARQ process was not successfully
    decoded:
    3> start the drx-RetransmissionTimerDL for the corresponding
      HARQ process in the first symbol after the expiry of
      drx-HARQ-RTT-TimerDL.
1> if a drx-HARQ-RTT-TimerUL or drx-HARQ-RTT-TimerUL-NTN
expires:
  2> start the drx-RetransmissionTimerUL for the corresponding HARQ
    process in the first symbol after the expiry of
    drx-HARQ-RTT-TimerUL.
```

When PDCCH indicates a downlink or uplink transmission, the UE needs to decide whether the new introduced timer drx-HARQ-RTT-TimerDL-NTN, or drx-HARQ-RTT-TimerUL-NTN is configured. When the two timers are configured, it suggests that the UE is served by the NTN nodes, thus should use the timer drx-HARQ-RTT-TimerDL-NTN, or the timer drx-HARQ-RTT-TimerUL-NTN the timer instead of the timers configured by non-NTN nodes. The 3GPP specification might be modified as follows (the modified parts are underlined):

```
1> if the MAC entity is in Active Time:
  2> monitor the PDCCH as specified in TS 38.213 [6];
  2> if the PDCCH indicates a DL transmission:
    3> if drx-HARQ-RTT-TimerDL-NTN is configured
      4> start the drx-HARQ-RTT-TimerDL-NTN for the
        corresponding HARQ process in the first symbol after the
        end of the corresponding transmission carrying the
        DL HARQ feedback. regardless of LBT failure indication
        from lower layers;
    3> else
      4> start the drx-HARQ-RTT-TimerDL for the corresponding
        HARQ process in the first symbol after the end of the
        corresponding transmission carrying the DL HARQ feedback,
        regardless of LBT failure indication from lower layers;
  2> if the PDCCH indicates a UL transmission:
    3> if drx-HARQ-RTT-TimerUL-NTN is configured
      4> start the drx-HARQ-RTT-TimerUL-NTN for the
        corresponding HARQ process in the first symbol after the
        end of the first repetition of the corresponding
        PUSCH transmission, regardless of LBT failure
        indication from lower layers;
    3> else
      4> start the drx-HARQ-RTT-TimerUL for the corresponding
        HARQ process in the first symbol after the end of the first
        repetition of the corresponding PUSCH transmission,
        regardless of LBT failure indication from lower layers;
    3> stop the drx-RetransmissionTimerUL for the corresponding
      HARQ process.
```

The BS may further transmit adjustment configuration to the UE. The adjustment configuration may include at least one of the following parameters: an indicator for enabling the UE to perform the adjustment of the DRX RTT timer, an indicator for the period of adjustment, a timer for the adjustment, and the specific offset value. The adjustment configuration may be transmitted to the UE in PDCCH or MAC CE.

The indicator for enabling the UE based adjustment is transmitted to the UE via RRC signaling with a size of 1 bit. If bit value=1, then the UE will adjust offset value based on network configuration, otherwise, the UE will not adjust offset value. Alternatively, if the bit value=0, the UE will adjust offset value based on network configuration, otherwise, the UE will not adjust offset value.

When the UE is allowed to adjust the offset value, the network can further configure how long will the UE perform adjustment for offset value, which may be realized by periodical adjustment or an adjustment timer. For one example, the network configures a periodic value to the UE, and the UE will periodically adjust offset value according to network configured periodical value. For another example, the network configures a timer for the UE, and the UE will start the timer when the UE determines the offset value, the UE starts the DRX RTT timer, or UE adjusts the offset value in last time. When the timer expires, the UE adjusts the offset value.

Furthermore, the network can configure the adjustment step to the UE, in each time the UE adjusts the offset value, the UE adjusts the offset value by adding one adjustment step from network.

In another embodiment, the UE can adjust the offset value by network indication. Network can indicate offset adjustment via PDCCH or MAC CE, then the UE adjusts the offset value according to received offset adjustment command. For example, the UE has an initial offset value x from e.g. system information. Then after some time, the network indicates an adjustment value y in PDCCH or MAC CE, in which y can be a positive or a negative value, and the UE may adjust the offset value by adding x with y, e.g. x=x+y. The UE then applies the updated x for the DRX RTT timer as follows:

drx-HARQ-RTT-TimerDL=drx-HARQ-RTT-TimerDL+x; and i.

drx-HARQ-RTT-TimerUL=drx-HARQ-RTT-TimerUL+x. ii.

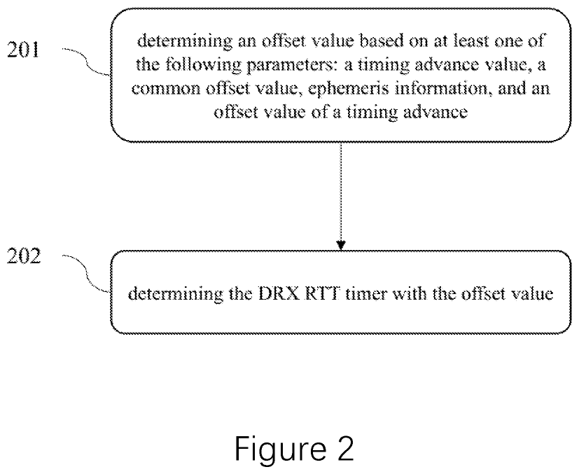

FIG. 2 illustrates one method performed by a UE for wireless communication according to a preferred embodiment of the subject disclosure.

In step 201, the UE determines an offset value based on at least one of the following parameters:
i. a timing advance value, i.e. N_{TA}, which is obtained from the physical layer;
ii. a common offset value, which is indicated in system information broadcasted by a BS;
iii. ephemeris information; and
iv. an offset value of a timing advance, which is indicated in TAC MAC CE.

In step 202, the UE determines the DRX RTT timer with the offset value.

There are different timing occasions for the UE to determine the offset, for example, the UE may:
i. determine the offset value after a TAC MAC CE being received and applied, and the TAC MAC CE may be received in a random access response message or in a Message B (MSGB);
ii. determine the offset value after an Absolute TAC being received in response to a MSGA transmission and after the Absolute TAC being applied;
iii. determine the offset value after DRX being configured or reconfigured; and
iv. determine the offset value before a timer for uplink or downlink transmission of DRX RTT HARQ being started.

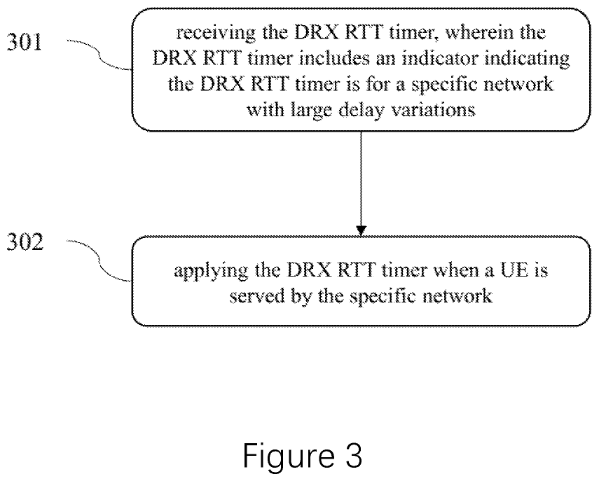

FIG. 3 illustrates another method performed by a UE for wireless communication according to a preferred embodiment of the subject disclosure.

In step 301, the UE receives the DRX RTT timer, wherein the DRX RTT timer includes an indicator indicating the DRX RTT timer is for a specific network with large delay variations. In step 302, the UE applies the DRX RTT timer when a UE is served by the specific network. For example, the specific network might be the NTN, which has large RTD, and some NTNs have large delay variation.

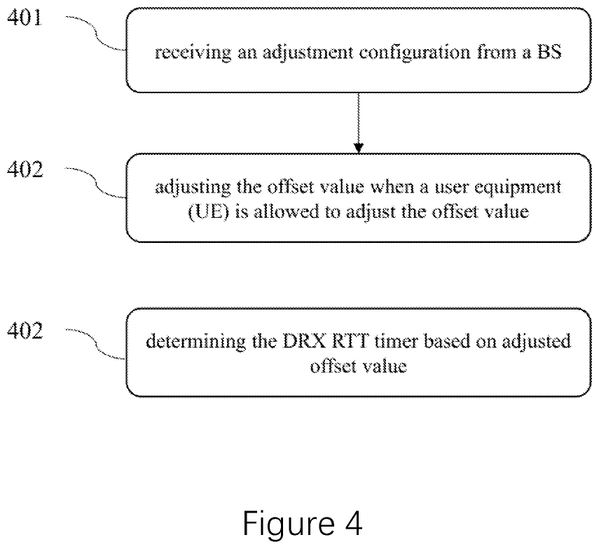

FIG. 4 illustrates another method performed by a UE for wireless communication according to a preferred embodiment of the subject disclosure.

In step 401, the UE receives an adjustment configuration from the BS; in step 402, the UE adjusts the offset value when the UE is allowed to adjust the offset value; and in step 403, the UE determines the DRX RTT timer based on adjusted offset value.

The adjustment configuration may include an indicator for allowing the UE to adjust the offset value. If the UE is allowed to adjust the offset value, the UE may adjust the offset value periodically with a period indicated in the adjustment configuration, or adjust the offset value when a timer in the adjustment configuration expires. The BS may further transmit the adjustment value in the adjustment configuration to UE, and UE adjusts the offset value using the adjustment value. The BS may also broadcast a common offset value indicated in the system information, and after receiving the common offset value, the UE adjusts the offset value with the common offset value.

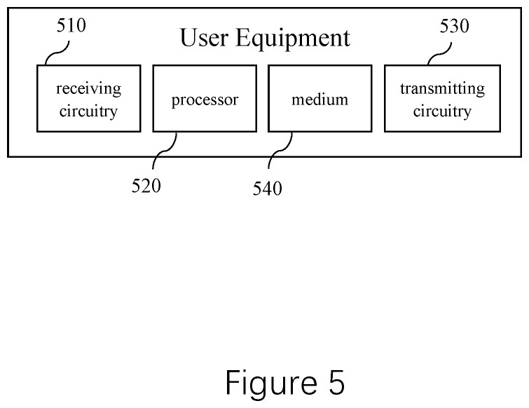

FIG. 5 illustrates a block diagram of a UE according to some embodiments of the present disclosure. The UE 101-A may include a receiving circuitry, a processor, and a transmitting circuitry. In one embodiment, the UE 101-A may include a non-transitory computer-readable medium having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g. the method in FIG. 2) with the receiving circuitry, the transmitting circuitry and the processor. That is, upon performing the computer executable instructions, the processor may determine an offset value based on at least one of the following parameters: a timing advance value, a common offset value, ephemeris information, and an offset value of a timing advance, and determine the DRX RTT timer with the offset value.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1-17. (canceled)

18. An apparatus, comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry,
wherein the computer-executable instructions cause the processor to implement a method for determining a Discontinuous Reception (DRX) Round-Trip Time (RTT) timer, the method comprising:
determining an offset value based on at least one of the following parameters: a timing advance value, a common offset value, ephemeris information, and an offset value of a timing advance; and
determining the DRX RTT timer with the offset value.

19. The apparatus of claim 18, wherein the timing advance value is obtained from physical layer.

20. The apparatus of claim 18, wherein the common offset value is indicated in system information broadcasted by a Base Station (BS).

21. The apparatus of claim 18, wherein the offset value of a timing advance is indicated in Timing Advance Command (TAC) Medium Access Control (MAC) Control Element (CE).

22. The apparatus of claim 18, wherein determining the offset value further comprises:
determining the offset value after a Timing Advance Command (TAC) Medium Access Control (MAC) Control Element (CE) being received and applied.

23. The apparatus of claim 22, wherein the TAC MAC CE is received in a random access response message or in a Message B (MSGB).

24. The apparatus of claim 18, wherein determining the offset value further comprises:
determining the offset value after an Absolute Timing Advance Command (TAC) being received in response to a Message A (MSGA) transmission and after the Absolute TAC being applied.

25. The apparatus of claim 18, wherein determining the offset value further comprises:
determining the offset value after DRX being configured or reconfigured.

26. The apparatus of claim 18, wherein determining the offset value further comprises:
determining the offset value before a timer for uplink or downlink transmission of DRX RTT HARQ being started.

27. An apparatus, comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry,
wherein the computer-executable instructions cause the processor to implement a method for determining a Discontinuous Reception (DRX) Round-Trip Time (RTT) timer, the method comprising:
receiving an adjustment configuration from a base station (BS);
adjusting the offset value when a user equipment (UE) is allowed to adjust the offset value; and
determining the DRX RTT timer based on adjusted offset value.

28. The apparatus of claim 27, further comprising:
determining the UE is allowed to adjust the offset value based on the adjustment configuration.

29. The apparatus of claim 27, wherein adjusting the offset value further comprises:
adjusting the offset value periodically with a period indicated in the adjustment configuration.

30. The apparatus of claim 27, wherein adjusting the offset value further comprises:
adjusting the offset value when a timer in the adjustment configuration expires.

31. The apparatus of claim 27, wherein adjusting the offset value further comprises:
adjusting the offset value with an adjustment value indicated in in the adjustment configuration received from the BS.

32. The apparatus of claim 27, wherein adjusting the offset value further comprises:
adjusting the offset value with a common offset value indicated in system information broadcasted by the BS after an offset adjustment command being received.

33. A method for determining a Discontinuous Reception (DRX) Round-Trip Time (RTT) timer, the method comprising:
determining an offset value based on at least one of the following parameters: a timing advance value, a common offset value, ephemeris information, and an offset value of a timing advance; and
determining the DRX RTT timer with the offset value.

34. The method of claim 33, wherein the timing advance value is obtained from physical layer.

35. The method of claim 33, wherein the common offset value is indicated in system information broadcasted by a Base Station (BS).

36. The method of claim 33, wherein the offset value of a timing advance is indicated in Timing Advance Command (TAC) Medium Access Control (MAC) Control Element (CE).

37. The method of claim 33, wherein determining the offset value further comprises:
determining the offset value after a Timing Advance Command (TAC) Medium Access Control (MAC) Control Element (CE) is received and applied.
